(19) United States
(12) Patent Application Publication
(10) Pub. No.: US 2020/0338713 A1
(43) Pub. Date: Oct. 29, 2020

(54) GARDENING TOOL

(71) Applicant: Yao-Chung Huang, Changhua (TW)

(72) Inventor: Yao-Chung Huang, Changhua (TW)

(73) Assignee: HO CHENG GARDEN TOOLS CO., LTD., CHANGHUA (TW)

(21) Appl. No.: 16/398,077

(22) Filed: Apr. 29, 2019

(51) Int. Cl. B25G 1/04; A01G 3/025

(52) U.S. Cl. CPC B25G 1/04; A01G 3/025

(57) ABSTRACT

A gardening tool may include an outer tube, at least a middle tube, and an inner tube which are sleeved and connected in sequence. Each of a first end of the outer tube and a first end of the middle tube is connected to a pressing member, and through the pressing members, the middle tube and the inner tube are adapted to be firmly positioned after the middle tube is pulled out from the outer tube and the inner tube is pulled out from the middle tube to adjust the length of the gardening tool.

### FIELD OF THE INVENTION

The present invention relates to a gardening tool and more particularly to a telescopic gardening tool.

### BACKGROUND OF THE INVENTION

There are many tools used in gardening for various kinds of works, and the gardening scissors is one of the common tools. A conventional gardening scissors comprises a pair of blades, and each of the blades is connected to a long rod at a rear end thereof as a handle for a user. Moreover, a through hole is formed at a middle portion of the gardening scissors, and a screw or a bolt is adapted to penetrate through the through hole so as to pivotally connect the pair of blades with the handles. When the force is applied to the handles, the through hole with the screw is used as a pivot to make the blades open or close, so as to achieve the cutting action.

However, the conventional gardening scissors has following disadvantages: (i) the two handles cannot be adjusted in length, such that it is inconvenient for a user to trim branches and leaves which are at higher positions; and (ii) the combined length of the blades and handles will cause inconvenience in carrying or using if the length of the handles cannot be adjusted. Therefore, there remains a need for a new and improved design for a gardening tool to overcome the problems presented above.

### SUMMARY OF THE INVENTION

The present invention provides a gardening tool which comprises an outer tube, at least a middle tube, and an inner tube which are connected and sleeved in sequence. Each of a first end of the outer tube and a first end of the middle tube is connected to a pressing member, and through the pressing members, the middle tube and the inner tube are adapted to be firmly positioned after the middle tube is pulled out from the outer tube and the inner tube is pulled out from the middle tube to adjust the length of the gardening tool. Moreover, the outer tube comprises the first end and a second end while the middle tube has the first end and a second end, and the inner tube comprises a first end and a second end. The outer tube has a first locating groove axially formed on an outer periphery thereof and extended from the first end to the second end thereof. In addition, the middle tube has a second locating groove axially formed on an outer periphery thereof and extended from the first end to the second end thereof. Moreover, the inner tube comprises a third locating groove axially formed on an outer periphery thereof and extended from the first end to the second end thereof. The first locating groove, the second locating groove, and the third locating groove are located at corresponding positions. The first locating groove, the second locating groove, and the third locating groove respectively have at least a first protruding edge, at least a second protruding edge, and at least a third protruding edge. A first through hole is formed on the first locating groove adjacent to the first end of the outer tube while a second through hole is formed on the second locating groove adjacent to the first end of the middle tube. Each of the pressing members comprises a hollow fixed base, and the two fixed bases are respectively disposed on the first end of the outer tube and the first end of the middle tube. Each of the fixed bases comprises two third through holes penetrating therethrough at corresponding positions, and the two pair of third through holes are respectively aligned with the first through hole and the second through hole when the two pressing members are respectively disposed on the outer tube and the middle tube. Each of the fixed bases has a locating rib protruding from an inner wall thereof, and at least a recess is formed on the locating rib. Each of the third through holes has a hole edge to enable an axle to couple thereon, and each of fixed bases has two pulling units respectively and pivotally connected to the two third through holes through the two axles. Each of the pulling units comprises a connecting head pivotally connected to the third through hole, and a handle extended from an end of the connecting head is located out of the third through hole. Each of the connecting heads has at least an abutting block protruding from an inner surface thereof.

Comparing with conventional gardening tool, the present invention is advantageous because: (i) through cooperating of the outer tube, the middle tube, the inner tube and the pressing members, the length of the gardening tool of the present invention can be adjusted according to the actual needs, which is convenient for use, carry or storage; (ii) when the pressing member is at the tightening position, the two pulling units are simultaneously abutted against to two sides of the middle tube or two sides of the inner tube so as to prevent the middle tube or inner tube from leaning toward one side due to uneven force; and (iii) the first protruding edge, the second protruding edge, and the third protruding edge are adapted to enhance the structural strength of the middle tube and the inner tube so as to prevent the middle tube and the inner tube from being deformed when pressed by the pulling units.

### BRIEF DESCRIPTION OF THE DRAWINGS

FIG. 1 is a three-dimensional view of a gardening tool of the present invention.

FIG. 2 is a three-dimensional exploded view of the gardening tool of the present invention.

FIG. 3 is an enlarged sectional view of a fixed base of the gardening tool of the present invention.

FIG. 4 is a schematic view illustrating a pressing member of the gardening tool is loosen from a tightening position in the present invention.

FIG. 5 is a schematic view illustrating a middle tube and an inner tube are pulled out in sequence in the present invention.

FIG. 6 is a schematic view illustrating the middle tube and the inner tube are positioned after pulled in the present invention.

FIG. 7 is a schematic view illustrating the gardening tool is connected to a long reach cutter.

FIG. 8 is a schematic view illustrating the gardening tool is connected to a blades.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

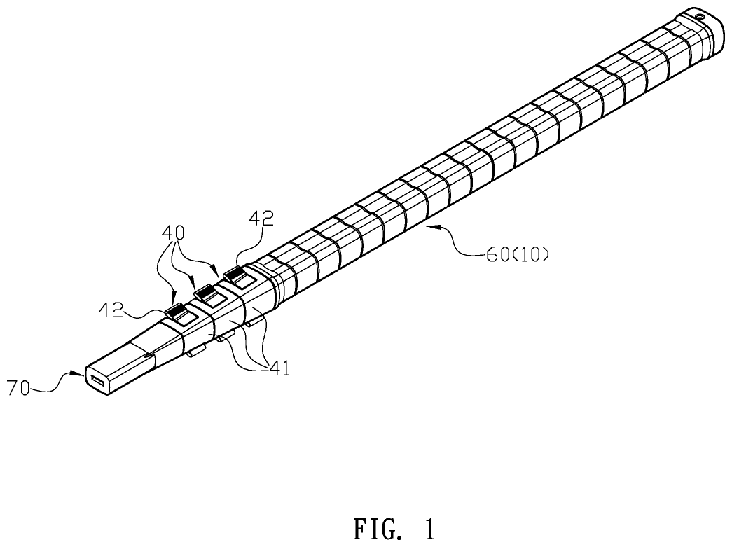

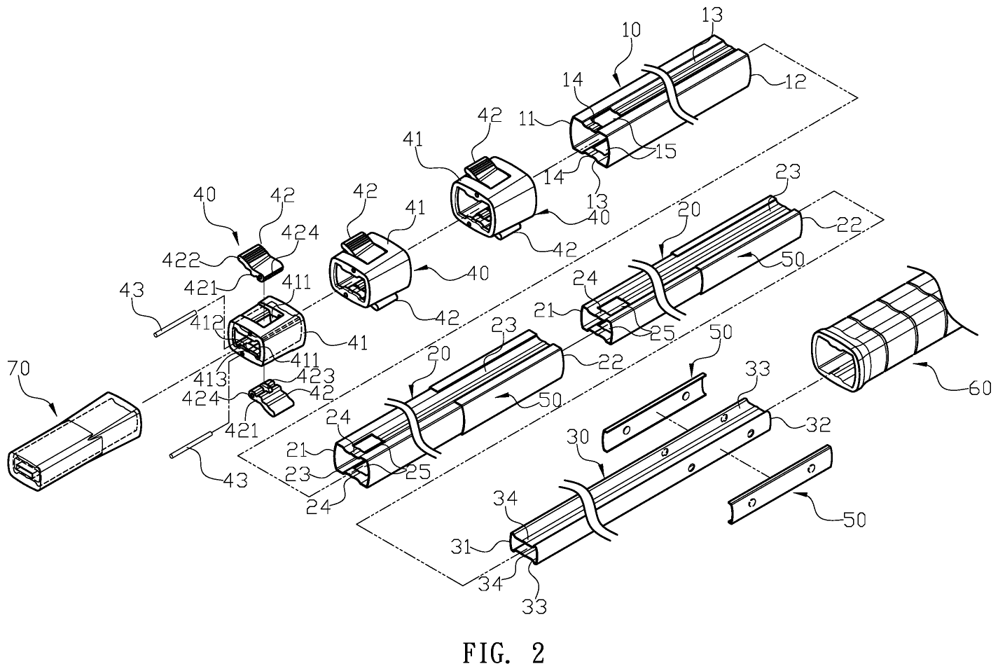

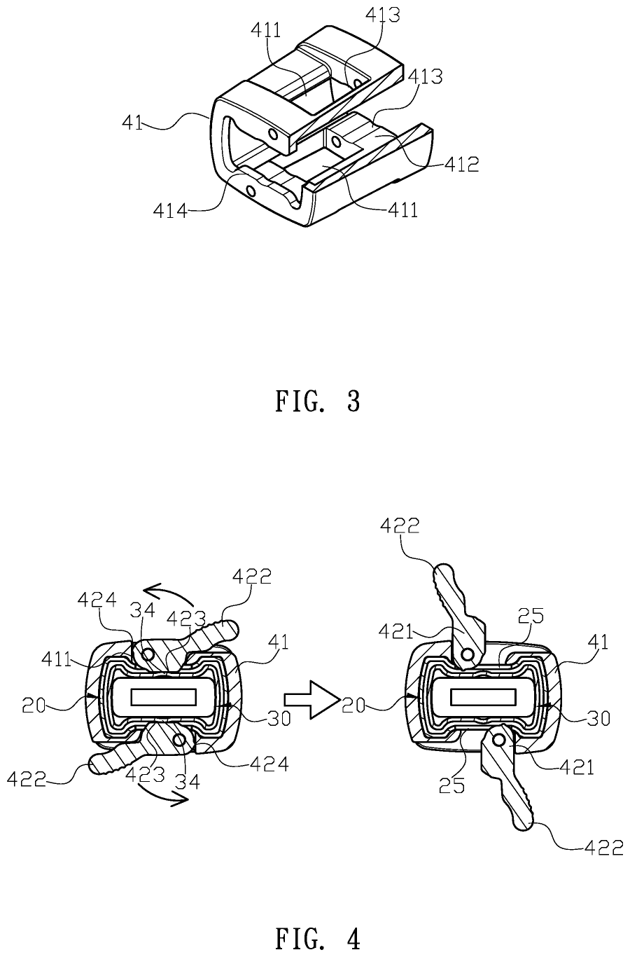

Referring to FIGS. 1 to 3, the present invention provides a gardening tool which comprises an outer tube (10), at least a middle tube (20), and an inner tube (30) which are connected and sleeved in sequence. Each of a first end (11) of the outer tube (10) and a first end (21) of the middle tube (20) is connected to a pressing member (40), and through the pressing members (40), the middle tube (20) and the inner tube (30) are adapted to be firmly positioned after the middle tube (20) is pulled out from the outer tube (10) and the inner tube (30) is pulled out from the middle tube (20) to adjust the length of the gardening tool. Moreover, the outer tube (10) comprises the first end (11) and a second end (12) while the middle tube (20) has the first end (21) and a second end (22). Also, the inner tube (30) comprises a first end (31) and a second end (32). Also, the outer tube (10) has a first locating groove (13) axially formed on an outer periphery thereof and extended from the first end (11) to the second end (12) thereof. In addition, the middle tube (20) comprises a second locating groove (23) axially formed on an outer periphery thereof and extended from the first end (21) to the second end (22) thereof. Moreover, the inner tube (30) has a third locating groove (33) axially formed on an outer periphery thereof and extended from the first end (31) to the second end (32) thereof. The first locating groove (13), the second locating groove (23), and the third locating groove (33) are located at corresponding positions. The first locating groove (13), the second locating groove (23), and the third locating groove (33) respectively have at least a first protruding edge (14), at least a second protruding edge (24), and at least a third protruding edge (34). A first through hole (15) is formed on the first locating groove (13) adjacent to the first end (11) of the outer tube (10) while a second through hole (25) is formed on the second locating groove (23) adjacent to the first end (21) of the middle tube (20). Each of the pressing members (40) comprises a hollow fixed base (41), and the two fixed bases (41) are respectively disposed on the first end (11) of the outer tube (10) and the first end (21) of the middle tube (20). Additionally, each of the fixed bases (41) comprises two third through holes (411) penetrating therethrough at corresponding positions, and the two pair of third through holes (411) are respectively aligned with the first through hole (15) and the second through hole (25) when the two pressing members (40) are respectively disposed on the outer tube (10) and the middle tube (20). Also, each of the fixed bases (41) has a locating rib (412) protruding from an inner wall thereof, and at least a recess (413) is formed on the locating rib (412). Each of the third through holes (411) has a hole edge to enable an axle (43) to couple thereon, and each of pulling units (42) is pivotally connected to the third through hole (411) through the axle (43). Also, the pulling unit (42) comprises a connecting head (421) pivotally connected to the third through hole (411), and a handle (422) extended from an end of the connecting head (421) is located out of the third through hole (411). Moreover, each of the connecting heads (421) has at least an abutting block (423) protruding from an inner surface thereof.

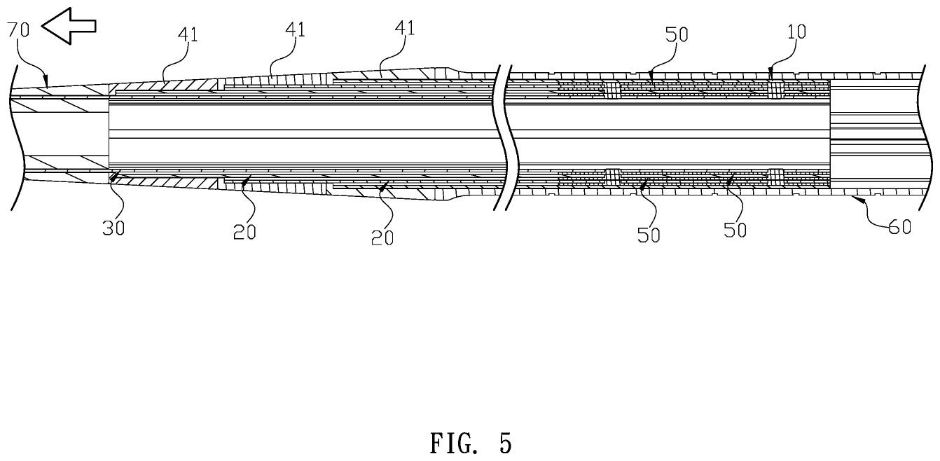

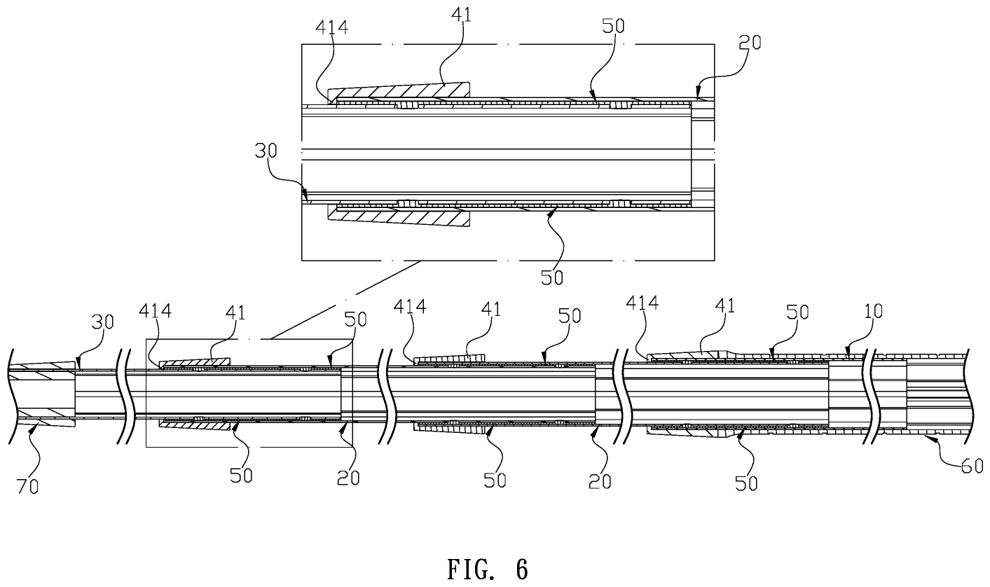

Structurally, referring to FIG. 1, the outer tube (10), the middle tube (20), and the inner tube (30) are connected and sleeved together in sequence, and the two pressing members (40) are respectively installed on the first end (11) of the outer tube (10) and the first end (21) of the middle tube (20), such that the two locating ribs (412) are respectively engaged with the first locating groove (13) and the second locating groove (23). Moreover, the first protruding edge (14) and the second protruding edge (24) are respectively accommodated in the recesses (413), and the first through hole (15) and the second through hole (25) are aligned with the two pair of third through holes (411) respectively. The first locating groove (13), the second locating groove (23), and the third locating groove (33) are sequentially connected so as to prevent the outer tube (10), the middle tube (20), and the inner tube (30) from having relative rotations after connected. Each of the pulling units (42) is operated through the handle (422) so as to drive the connecting head (421) to be at a tightening position or at a loose position (as shown in FIG. 4). When the connecting heads (421) are at the tightening position, the abutting block (423) of the pressing member (40) on the outer tube (10) is adapted to abut against the second protruding edge (24) of the middle tube (20), and the abutting block (423) of the pressing member (40) on the middle tube (20) is configured to abut against the third protruding edge (34) of the inner tube (30), so that the length of the gardening tool is secured. On the other hand, when the connecting heads (421) are at the loose position, the abutting blocks (423) respectively on the outer tube (10) and the middle tube (20) are detached from the second protruding edge (24) and the third protruding edge (34), so that the middle tube (20), the inner tube (30), or both of the middle tube (20) and the inner tube (30) is configured to be selectively adjusted in length (as shown in FIGS. 5 and 6). Thus, the gardening tool can be adjusted into a most suitable length for use or carry.

In one embodiment, the gardening tool comprises two middle tubes (20), and each of the middle tubes (20) has a pressing member (40) installed thereon.

In another embodiment, the first protruding edge (14), the second protruding edge (24), and the third protruding edge (34) are axially formed along the outer tube (10), the middle tube (20), and the inner tube (30) respectively.

In still another embodiment, each of the connecting heads (421) has at least an abutting rib (424) formed at an end of the connecting head (421) opposite to the handle (422), and the abutting rib (424) is borne against the hole edge of the third through hole (411) when the connecting head (421) of the pulling unit (42) is at the tightening position so as to secure the position of the pulling unit (42).

In a further embodiment, each of the middle tube (20) and the inner tube (30) has a sliding piece (50) installed at positions adjacent to the second ends (22)(23) thereof, and each of the fixed bases (41) comprises a block edge (414) protruding from an inner surface thereof, and the sliding piece (50) and the block edge (414) are configured to limit positions for each other so as to prevent the middle tube (20) and the inner tube (30) from detached from the outer tube (10) and the middle tube (20) due to been pulled too hard by a user, and each of the sliding pieces (50) is adapted to fill gaps between the tubes.

In still a further embodiment, a holding sleeve (60) is disposed on the outer tube (10) to provide the anti-slip effect and better touch.

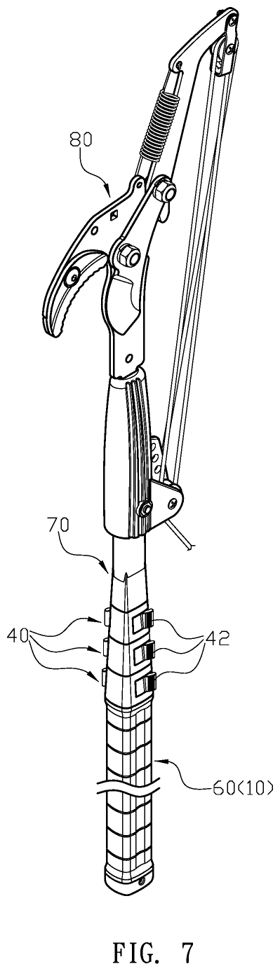

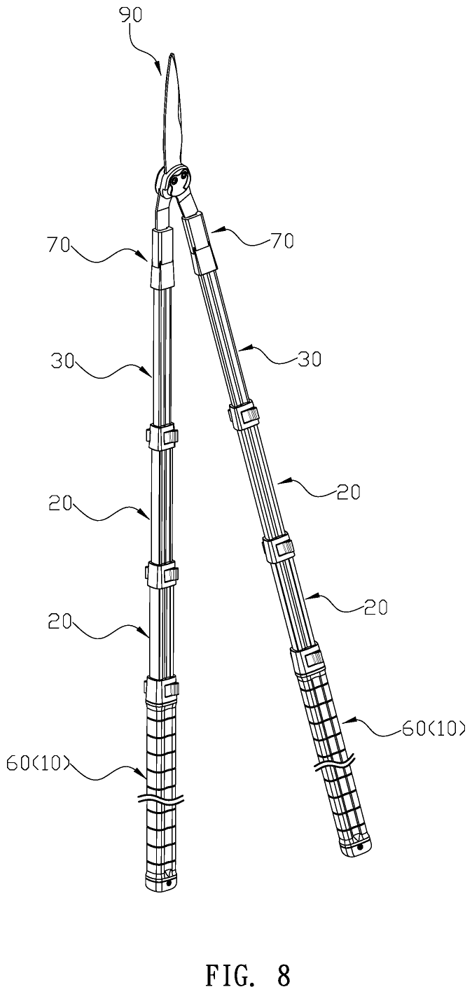

In a particular embodiment, the first end (31) of the inner tube (30), which is adapted to protrude from the middle tube (20), is provided to connect to a tool such as a long reach cutter (80) (as shown in FIG. 7) and a blades (90) (as shown in FIG. 8) through a connecting block (70).

Comparing with conventional gardening tool, the present invention is advantageous because: (i) through cooperating of the outer tube (10), the middle tube (20), the inner tube (30) and the pressing members (40), the length of the gardening tool of the present invention can be adjusted according to the actual needs, which is convenient for use, carry or storage; (ii) when the pressing member (40) is at the tightening position, the two pulling units (42) are simultaneously abutted against to two sides of the middle tube (20) or two sides of the inner tube (30) so as to prevent the middle tube (20) or inner tube (30) from leaning toward one side due to uneven force; and (iii) the first protruding edge (14), the second protruding edge (24), and the third protruding edge (34) are adapted to enhance the structural strength of the middle tube (20) and the inner tube (30) so as to prevent the middle tube (20) and the inner tube (30) from being deformed when pressed by the pulling units (42).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A gardening tool comprising an outer tube, at least a middle tube, and an inner tube which are connected and sleeved in sequence, and each of a first end of the outer tube and a first end of the middle tube connected to a pressing member, and through the pressing members, the middle tube and the inner tube adapted to be firmly positioned after the middle tube pulled out from the outer tube and the inner tube pulled out from the middle tube to adjust the length of the gardening tool;
wherein the outer tube comprises the first end and a second end while the middle tube has the first end and a second end, and the inner tube comprises a first end and a second end; the outer tube has a first locating groove axially formed on an outer periphery thereof and extended from the first end to the second end thereof, and the middle tube has a second locating groove axially formed on an outer periphery thereof and extended from the first end to the second end thereof, and the inner tube comprises a third locating groove axially formed on an outer periphery thereof and extended from the first end to the second end thereof, and the first locating groove, the second locating groove, and the third locating groove are located at corresponding positions; the first locating groove, the second locating groove, and the third locating groove respectively have at least a first protruding edge, at least a second protruding edge, and at least a third protruding edge; a first through hole is formed on the first locating groove adjacent to the first end of the outer tube while a second through hole is formed on the second locating groove adjacent to the first end of the middle tube;
wherein each of the pressing members comprises a hollow fixed base, and the two fixed bases are respectively disposed on the first end of the outer tube and the first end of the middle tube; each of the fixed bases comprises two third through holes penetrating therethrough at corresponding positions, and the two pair of third through holes are respectively aligned with the first through hole and the second through hole when the two pressing members are respectively disposed on the outer tube and the middle tube; each of the fixed bases has a locating rib protruding from an inner wall thereof, and at least a recess is formed on the locating rib; each of the third through holes has a hole edge to enable an axle to couple thereon, and each of fixed bases has two pulling units respectively and pivotally connected to the two third through holes through the two axles; each of the pulling units comprises a connecting head pivotally connected to the third through hole, and a handle extended from an end of the connecting head is located out of the third through hole; each of the connecting heads has at least an abutting block protruding from an inner surface thereof; and
wherein the outer tube, the middle tube, and the inner tube are connected and sleeved together in sequence, and the two pressing members are respectively installed on the first end of the outer tube and the first end of the middle tube, and the two locating ribs are respectively engaged with the first locating groove and the second locating groove; the first protruding edge and the second protruding edge are respectively accommodated in the recesses, and the first through hole and the second through hole are aligned with the two pair of third through holes respectively; the first locating groove, the second locating groove, and the third locating groove are sequentially connected so as to prevent the outer tube, the middle tube, and the inner tube from having relative rotations after connected; each of the pulling units is operated through the handle so as to drive the connecting head to be at a tightening position or at a loose position; when the connecting heads are at the tightening position, the abutting block of the pressing member on the outer tube is adapted to abut against the second protruding edge of the middle tube, and the abutting block of the pressing member on the middle tube is configured to abut against the third protruding edge of the inner tube, so that the length of the gardening tool is secured; when the connecting heads are at the loose position, the abutting blocks respectively on the outer tube and the middle tube are detached from the second protruding edge and the third protruding edge, so that the middle tube, the inner tube or both of the middle tube and the inner tube is configured to be selectively adjusted in length.

2. The gardening tool of claim 1, wherein the gardening tool comprises two middle tubes, and each of the middle tubes has a pressing member installed thereon.

3. The gardening tool of claim 1, wherein the first protruding edge, the second protruding edge, and the third protruding edge are axially formed along the outer tube, the middle tube, and the inner tube respectively.

4. The gardening tool of claim 1, wherein each of the connecting heads has at least an abutting rib formed at an end of the connecting head opposite to the handle.

5. The gardening tool of claim 1, wherein each of the middle tube and the inner tube has a sliding piece installed at positions adjacent to the second ends thereof, and each of the fixed bases comprises a block edge protruding from an inner surface thereof.

6. The gardening tool of claim 1, wherein a holding sleeve is disposed on the outer tube to provide the anti-slip effect and better touch.

7. The gardening tool of claim 1, wherein the first end of the inner tube, which is adapted to protrude from the middle tube, is provided to connect to a tool.
